(19) United States
(12) Patent Application Publication
(10) Pub. No.: US 2008/0254250 A1
(43) Pub. Date: Oct. 16, 2008

(54) Image recording media and image layers

(76) Inventors: Vladek Kasperchik, Corvallis, OR (US); Molly L. Hladik, Corvallis, OR (US); Susan E. Bailey, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/784,819

(22) Filed: Apr. 10, 2007

(51) Int. Cl. B32B 1/00; B05D 5/06; G03C 1/50

(52) U.S. Cl. 428/64.4; 427/162; 430/178

(57) ABSTRACT

Imaging layers, image recording media, and methods of preparation of each, are disclosed.

### BACKGROUND

Compositions that produce a color change upon exposure to energy in the form of light are of great interest in producing images on a variety of substrates. For example, labeling of optical storage media such as Compact Discs, Digital Video Discs or Blue Laser Discs (CD, DVD, or Blue Laser Disc) can be routinely accomplished through screen-printing methods. While this method can provide a wide variety of label content, it tends to be cost ineffective for run lengths less than 300-400 discs because the fixed cost of unique materials and set-up are shared by all the discs in each run. In screen-printing, a stencil of the image is prepared, placed in contact with the disc and then ink is spread by squeegee across the stencil surface. Where there are openings in the stencil the ink passes through to the surface of the disc, thus producing the image. Preparation of the stencil can be an elaborate, time-consuming and expensive process.

In recent years, significant increases in use of CD/DVD discs as a data distribution vehicle have increased the need to provide customized label content to reflect the data content of the disc. For these applications, the screen-label printing presents a dilemma as discs are designed to permit customized user information to be recorded in standardized CD, DVD, or Blue Laser Disc formats. Today, for labeling small quantities of discs, popular methods include hand labeling with a permanent marker pen, using an inkjet printer to print an adhesive paper label, and printing directly with a pen on the disc media which has a coating that has the ability to absorb inks. The hand printing methods do not provide high quality and aligning a separately printed label by hand is inexact and difficult.

It may therefore be desirable to design an optical data recording medium (e.g., CD, DVD, or Blue Laser Disc) which can be individually labeled by the user easily and inexpensively relative to screen-printing while giving a high quality label solution. It may also be desirable to design an optical data recording medium that accepts labeling via multiple methods, thus reducing the amount of inventory necessarily carried by optical data recording merchants and end users.

A variety of leuco dye-containing compositions have been investigated for use on optical disks and other substrates. Leuco dye compositions include a leuco dye along with an optional activator and an infrared absorber. However, many of these compositions are insufficiently stable when exposed to oil during handling, and are not durable enough for practical use. For this and other reasons, the need still exists for optical storage media that have improved oil resistance.

### SUMMARY

Briefly described, embodiments of this disclosure include image recording coatings, optical disks including the image recording coatings, and method for preparing a recording medium. One exemplary embodiment of the image recording coating, among others, includes: a substrate having a layer disposed thereon, wherein the layer includes: a matrix; a radiation-absorbing compound; an activator, wherein the activator is a metal salt of ethylenically unsaturated monocarboxylic acid; and a color former.

One exemplary embodiment of the optical disk, among others, includes: an image recording coating as described above.

One exemplary embodiment of the method for preparing a recording medium, among others, includes: providing a matrix, a radiation-absorbing compound, an activator, and a color former, wherein the activator is a metal salt of ethylenically unsaturated monocarboxylic acid; mixing the radiation-absorbing compound, the activator, and the color former, in the matrix to form a matrix mixture; and disposing the matrix mixture onto a substrate.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates an illustrative embodiment of the imaging medium.

FIG. 2 illustrates a representative embodiment of a printer system.

### DETAILED DESCRIPTION

Embodiments of the present disclosure will employ, unless otherwise indicated, techniques of synthetic organic chemistry, ink chemistry, media chemistry, and the like, that are within the skill of the art. Such techniques are explained fully in the literature.

The following examples are put forth so as to provide those of ordinary skill in the art with a complete disclosure and description of how to perform the methods and use the compositions disclosed and claimed herein. Efforts have been made to ensure accuracy with respect to numbers (e.g., amounts, temperature, etc.) but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the term “leuco-dye” means a color-forming substance that is colorless or of a first color in a non-activated state, and subsequently exhibits color or changes from the first color to a second color in an activated state.

As used herein, the term “activator” is a substance that reacts with a color former such as a leuco-dye, causing the leuco-dye to alter its chemical structure and change or acquire color.

As used herein, the term “antenna” is a radiation-absorbing compound. The antenna readily absorbs a desired specific wavelength of the marking radiation.

### Discussion

Embodiments of the disclosure include image recording coatings, image recording media, and methods of making each. The image-recording medium includes an image layer or coating including, but not limited to, a matrix, a color former, a metal salt of ethylenically unsaturated monocarboxylic acid, and optionally a radiation-absorbing compound. Typical imaging layers including color formers (e.g., leuco dyes) are problematic because the colorants may be partially soluble in the polymer matrix (which contains a matrix soluble activator) and, thus, can develop color prior to being imaged. In contrast, the image layer including the metal salt of ethylenically unsaturated monocarboxylic acid does not develop prior to imaging and helps to lower background coloration of the coating and enables better imaging contrast. Embodiments of the present disclosure are advantageous because some transition metal salt of ethylenically unsaturated monocarboxylic acid strongly develops with many color formers (e.g., leuco dyes), but at the same time practically insoluble in the matrix at room temperature. It should also be noted that the metal salt of ethylenically unsaturated monocarboxylic acid might participate in the polymerization reactions during the coating cure and thus reinforce the coating structure through additional ionic cross-linking.

The image layer can be a coating disposed onto a substrate and used in structures such as, but not limited to, paper, digital recording material, cardboard (e.g., packaging box surface), plastic (e.g., food packaging surface), and the like.

A clear mark and excellent image quality can be obtained by directing radiation energy (e.g., a 780 nm laser operating at 35 mW) at areas of the image layer on which a mark is desired. As mentioned above, the components in the image layer used to produce the mark via a color change upon stimulation by energy can include, but is not limited to, the matrix, the color former (e.g., a leuco dye), an activator (e.g., metal salt of ethylenically unsaturated monocarboxylic acids), and, optionally, the radiation-absorbing compound. In an embodiment, the components can be dissolved into a matrix material. In another embodiment, one or more components can be insoluble or substantially insoluble in the matrix material at ambient temperatures, where the components are uniformly dispersed throughout the matrix material.

In an embodiment, when the radiation-absorbing compound absorbs particular radiation energy, the heat generated from the radiation-absorbing compound allows a reaction between the color former and the activator to occur and to produce a color change (e.g., a mark). In another embodiment, the radiation-absorbing compound is not used and the laser irradiation is directly absorbed by and heats the matrix material and its components, which allows the color former and the activator to react to produce a color change. In either embodiment, the metal ions from the metal salt of the ethylenically unsaturated monocarboxylic acid are released and develop the color former to produce a color change. The solubility of the activator at ambient temperatures is very low (the metal ion is not released), but the solubility increases (the metal ion is released) at elevated temperatures (e.g., those produced by the laser irradiation), and the metal ion reacts with the color former.

The radiation energy absorber functions to absorb radiation energy, convert the energy into heat, and deliver the heat to the components of the matrix. The radiation energy may then be applied by way of an infrared laser. Upon application of the radiation energy, both the color former and the activator may become heated and mix, which causes the color former to become activated and cause a mark (color) to be produced.

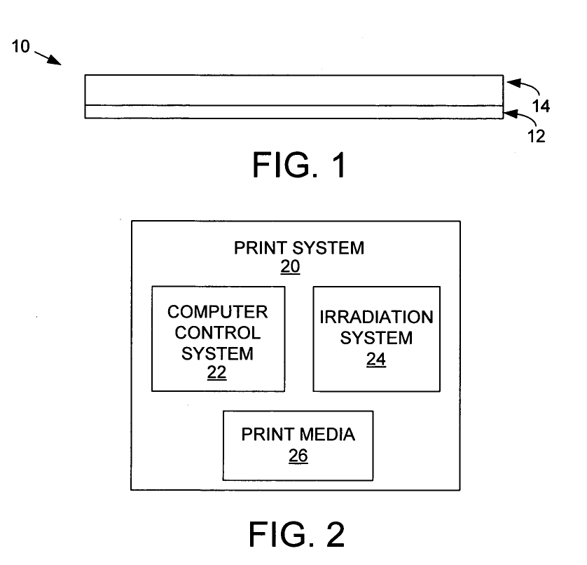

FIG. 1 illustrates an embodiment of an imaging medium 10. The imaging medium 10 can include, but is not limited to, a substrate 12 and a layer 14. The substrate 12 can be a substrate upon which it is desirable to make a mark, such as, but not limited to, paper (e.g., labels, tickets, receipts, or stationery), overhead transparencies, a metal/metal composite, glass, a ceramic, a polymer, and a labeling medium (e.g., a compact disk (CD) (e.g., CD-R/RW/ROM) and a digital versatile disk (DVD) (e.g., DVD-R/RW/ROM)). In particular, the substrate 12 includes an “optical disk” which is meant to encompass audio, video, multi-media, and/or software disks that are machine readable in a CD and/or DVD drive, or the like. Examples of optical disk formats include writeable, recordable, and rewriteable disks such as DVD-HD, Blu-ray, DVD, DVD-R, DVD-RW, DVD+R, DVD+RW, DVD-RAM, CD, CD-ROM, CD-R, CD-RW, and the like. Other like formats can also be included, such as similar formats and formats to be developed in the future.

The layer 14 can include, but is not limited to, the matrix, the color former (e.g., a leuco dye), the activator (e.g., metal salt of ethylenically unsaturated monocarboxylic acids), and optionally the radiation-absorbing compound, as well as other components typically found in the particular media to be produced.

The layer 14 may be applied to the substrate 12 via any acceptable method, such as, but not limited to, rolling, spraying, and screen-printing. In addition, one or more layers can be formed between the layer 14 and the substrate 12 and/or one or more layer can be formed on top of the layer 14. In one embodiment, the layer 14 is part of a CD or a DVD.

To form a mark, radiation energy is directed imagewise at one or more discrete areas of the layer 14 of the imaging medium 10. The form of radiation energy may vary depending upon the equipment available, ambient conditions, the desired result, and the like. The radiation energy can include, but is not limited to, infrared (IR) radiation, ultraviolet (UV) radiation, x-rays, and visible light. In an embodiment, the radiation-absorbing compound absorbs the radiation energy and heats the area of the layer 14 to which the radiation energy impacts. The heat may cause the color former and the activator to mix. The color former and the activator may then react (the metal ion reacts with the color former) to form a mark (color) on certain areas of the layer 14.

FIG. 2 illustrates a representative embodiment of a print system 20. The print system 20 can include, but is not limited to, a computer control system 22, an irradiation system 24, and print media 26 (e.g., imaging medium). The computer control system 22 is operative to control the irradiation system 24 to cause marks (e.g., printing of characters, symbols, photos, and the like) to be formed on the print media 26. The irradiation system 24 can include, but is not limited to, a laser system, UV energy system, IR energy system, visible energy system, x-ray system, and other systems that can produce radiation energy to cause a mark to be formed on the layer 14. The print system 20 can include, but is not limited to, a laser printer system and an ink-jet printer system. In addition, the print system 20 can be incorporated into a digital media system. For example, the print system 20 can be operated in a digital media system to print labels (e.g., the layer is incorporated into a label) onto digital media such as CDs and DVDs. Furthermore, the print system 20 can be operated in a digital media system to directly print onto the digital media (e.g., the layer is incorporated the structure of the digital media).

As mentioned above, the image layer can include, but is not limited to, the matrix, the color former (e.g., a leuco dye), the activator (e.g., metal salt of ethylenically unsaturated monocarboxylic acids), and optionally the radiation-absorbing compound.

The matrix 16 (also referred to as “matrix material” and “matrix compound”) can include compounds capable of and suitable for dissolving and/or dispersing the radiation-absorbing compound, the activator, and/or the color former. The matrix 16 can include, but is not limited to, UV curable monomers, oligomers, and pre-polymers (e.g., acrylate derivatives). Illustrative examples of UV-curable monomers, oligomers, and pre-polymers (that may be mixed to form a suitable UV-curable matrix) can include but are not limited to, acrylic, methacrylic and allyl carbonate momoners (e.g., BX-946 (available form Hampford Research, Stratford, Conn.), hexamethylene diacrylate, tripropylene glycol diacrylate, lauryl acrylate, isodecyl acrylate, neopentyl glycol diacrylate, isobornyl acrylate, 2-phenoxyethyl acrylate, 2(2-ethoxy)ethylacrylate, polyethylene glycol diacrylate and other acrylated polyols, trimethylolpropane triacrylate, pentaerythritol tetraacrylate, ethoxylated bisphenol A diacrylate, acrylic oligomers with epoxy functionality, and the like.

In addition, the matrix can include, but is not limited to, UV curable matrices such as acrylate derivatives, oligomers and monomers, with a photopackage. A photopackage may include light absorbing species that initiate reactions for curing of a lacquer, such as, by way of example, benzophenone derivatives. Other examples of photoinitiators for free radical polymerization monomers and pre-polymers include but are not limited to thioxanthone derivatives, anthraquinone derivatives, acetophenones and benzoine ethers.

In an embodiment, it may be desirable to choose a matrix that is cured by a form of radiation that does not cause a color change either by itself or through interaction with color-forming components. An example of a matrix is a mixture of UV curable acrylate monomers and oligomers that contains a photoinitiator (hydroxy ketone) and a mixture of difunctional and monofunctional acrylates and methacrylates such as, but not limited to, hexanediol diacrylate, isobornyl acrylate, tripropyleneglycol diacrylate, bis-A epoxydiacrylate. Other matrix materials may include, but are not limited to, acrylated polyester oligomers, such as CN293 and CN294 as well as CN-292 (low viscosity polyester acrylate oligomer), SR-351 (trimethylolpropane triacrylate), SR-395 (isodecyl acrylate) and SR-256 (2(2-ethoxyethoxy)ethyl acrylate) (all of which are available from Sartomer Co.).

The matrix compound 16 is about 2 wt % to 98 wt % of the layer and about 20 wt % to 90 wt % of the layer.

The term “color former” is a color forming substance, which is colorless or one color in a non-activated state and produces or changes color in an activated state. The color former can include, but is not limited to, leuco dyes and phthalide color formers (e.g., fluoran leuco dyes and phthalide color formers as described in “The Chemistry and Applications of Leuco Dyes”, Muthyala, Ramiah, ed., Plenum Press (1997) (ISBN 0-306-45459-9), incorporated herein by reference).

The color former can include a wide variety of leuco dyes. Suitable leuco dyes include, but are not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)-4,5-diphenylimidazoles, indanones, leuco indamines, hydrozines, leuco indigoid dyes, amino-2,3-dihydroanthraquinon-es, tetrahalo-p,p′-biphenols, 2(p-hydroxyphenyl)-4,5-diphenylimidazoles, phenethylanilines, phthalocyanine precursors (such as those available from Sitaram Chemicals, India), and other known leuco dye compositions. Experimental testing has shown that phthalide and fluoran-based dyes are one class of leuco dyes that exhibit particularly desirable properties.

In one aspect of the present disclosure, the leuco dye can be a fluoran, phthalide, aminotriarylmethane, or mixture thereof. Several non-limiting examples of suitable fluoran based leuco dyes include 3-diethylamino-6-methyl-7-anilinofluorane, 3-(N-ethyl-p-toluidino)-6-meth-yl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-N-methylamino)-6-methyl-7-anilinofluorane, 3-diethylamino-7-(m-trifluoromethylanilino)fluorane, 3-dibutylamino-6-methyl-7-anilinofluoran-e, 3-diethylamino-6-chloro-7-anilinofluorane, 3-dibutylamino-7-(o-chloroanilino)fluorane, 3-diethylamino-7-(o-chloroanilino)fluorane, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofuranone,4,5,6,7-t-etrachloro-3,3-bis[2-[4-(dimethylamino)phenyl]-2-(4-methoxyphenyl)ethenyl]-, 2-anilino-3-methyl-6-(N-ethyl-N-isoamylamino)fluorane (S-205 available from Nagase Co., Ltd), and mixtures thereof. Suitable aminotriarylmethane leuco dyes can also be used in the present invention such as tris(N,N-dimethylaminophenyl)methane (LCV); tris(N,N-diethylaminophenyl)methane (LECV); tris(N,N-di-n-propylaminophenyl)methane (LPCV); tris(N,N-di-n-butylaminophenyl)methane (LBCV); bis(4-diethylaminophenyl)-(4-diethylamino-2-methyl-phenyl)methane (LV-1); bis(4-diethylamino-2-methylphenyl)-(4-diethylamino-phenyl)methane (LV-2); tris(4-diethylamino-2-methylphenyl)methane (LV-3); bis(4-diethylamino-2-methylphenyl)(3,4-dimethoxy-phenyl)methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl. Other leuco dyes can also be used in connection with the present invention and are known to those skilled in the art. A more detailed discussion of some of these types of leuco dyes may be found in U.S. Pat. Nos. 3,658,543 and 6,251,571, each of which are hereby incorporated by reference in their entireties. Additional examples and methods of forming such compounds can be found in Chemistry and Applications of Leuco Dyes, Muthyala, Ramaiha, ed., Plenum Press, New York, London; ISBN: 0-306-45459-9, which is hereby incorporated by reference.

The color former may exist in the image layer as either: a) as a separate phase finely dispersed in the matrix phase (preferable for many fluoran Leuco-dyes) (e.g., Leuco-dye particle size <5 μm, preferably <2 μm, most preferably <1 μm). In this case heating of the coating by radiation results of Leuco-dye dissolution in the matrix; b) or being completely dissolved in the matrix phase at the stage of coating preparation. For example, some of the commercial phthalide Leuco-dyes such as 3,3′-Bis(1-n-octyl-2-methylindol-3-yl)phthalide commercially known as Pergascript Red I 6B or Specialty Red 16 have relatively high solubility (up to about 20 wt. %) in many commercially available acrylate and methacrylate monomers.

The color former is from about 2 wt % to 50 wt % of the layer and from about 5 wt % to 30 wt % of the layer.

As used herein, the term “activator” is a substance that reacts with a color former and causes the color former to alter its chemical structure and change or acquire color. The activator may include, but is not limited to, metal salt of ethylenically unsaturated monocarboxylic acids. In particular, the metal salt of ethylenically unsaturated monocarboxylic acid includes, but is not limited to, an alpha, beta ethylenically unsaturated monocarboxylic acid. The metal can include, but is not limited to, a Lewis acid transition metal (e.g., Cu, Ni, and Zn). In particular, the metal is zinc (Zn salts are colorless and, hence, do not affect background coloration and their toxicity is relatively low). The activator can include, but is not limited to, a zinc di- or mono-acrylate or methacrylate. The activator is from about 0.5 wt % to 50 wt % of the layer and, preferably, from about 2 wt % to 30 wt % of the layer.

Embodiments of the activator (e.g., metal salt acrylate or methacrylates) are dispersed as a separate phase in the matrix and the activator stays separated from the color former until the image layer is heated. In addition, the amount of activator is not limited as it is with other activator commonly used.

Embodiments of the activator can eventually become part of the matrix. For example, the metal salt of ethylenically unsaturated monocarboxylic acid may participate in the polymerization reactions during the coating cure as well as reinforce the coating structure through additional ionic cross-linking.

The term “radiation-absorbing compound” (e.g., “an antenna”) means any radiation-absorbing compound that readily absorbs a desired specific wavelength of the marking radiation. The radiation-absorbing compound can be a material that effectively absorbs the type of energy to be applied to the imaging medium 10 to effect a mark or color change.

The radiation-absorbing compound can act as an energy antenna, providing energy to surrounding areas upon interaction with an energy source. As a predetermined amount of energy can be provided by the radiation-absorbing compound, matching of the radiation wavelength and intensity to the particular antenna used can be carried out to optimize the system within a desired optimal range. Most common commercial applications can require optimization to a development wavelength of about 200 nm to about 1000 nm, although wavelengths outside this range can be used by adjusting the radiation-absorbing compound and color forming composition accordingly.

Suitable radiation-absorbing compound can be selected from a number of radiation absorbers such as, but not limited to, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof. Other suitable radiation-absorbing compounds can also be used and are known to those skilled in the art and can be found in such references as “Infrared Absorbing Dyes”, Matsuoka, Masaru, ed., Plenum Press, New York, 1990 (ISBN 0-306-43478-4) and “Near-Infrared Dyes for High Technology Applications”, Daehne, Resch-Genger, Wolfbeis, Kluwer Academic Publishers (ISBN 0-7923-5101-0), both incorporated herein by reference.

Various radiation-absorbing compounds can act as an antenna to absorb electromagnetic radiation of specific wavelengths and ranges. Generally, a radiation antenna that has a maximum light absorption at or in the vicinity of the desired development wavelength can be suitable for use in the present disclosure. For example, the color forming composition can be optimized within a range for development using infrared radiation having a wavelength from about 720 nm to about 900 nm. Common CD-burning lasers have a wavelength of about 780 nm and can be adapted for forming images by selectively developing portions of the image layer.

Radiation-absorbing compound which can be suitable for use in the infrared range can include, but are not limited to, polymethyl indoliums, metal complex IR dyes, indocyanine green, polymethine dyes such as pyrimidinetrione-cyclopentylidenes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexafunctional polyester oligomers, heterocyclic compounds, and combinations thereof.

Several specific polymethyl indolium compounds are available from Aldrich Chemical Company and include 2-[2-[2-chloro-3-[2-(1,3-dihydro-1,3,3-trimethyl-2/-/-indol-2-ylidene)-ethylidene]-1-cyclopenten-1-yl-ethenyl]-1,3,3-trimethyl-3/-/-indolium perchlorate; 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3W-indolium chloride; 2-[2-[2-chloro-3-[(1,3-dihydro-3,3-dimethyl-1-propyl-2H-indol-2-ylidene) ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene) ethylidene]-1-cyclohexen-1-yl]ethenyl]-1,3,3-trimethylindolium iodide; 2-[2-[2-chloro-3˜[(1,3-dihydro-1,3,v3-trimethyl-2H-indol-2-ylidene) ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene) ethylidene]-2-(phenylthio)-1-cyclohexen-1-yl]ethenyl]-3,3-dimethyl-1-propylindolium perchlorate; and mixtures thereof. Alternatively, the radiation-absorbing compound can be an inorganic compound (e.g., ferric oxide, carbon black, selenium, or the like). Polymethine dyes or derivatives thereof such as a pyrimidinetrione-cyclopentylidene, squarylium dyes such as guaiazulenyl dyes, croconium dyes, or mixtures thereof can also be used in the present invention. Suitable pyrimidinetrione-cyclopentylidene infrared antennae include, for example, 2,4,6(1 H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9Cl) (S0322 available from Few Chemicals, Germany).

In another embodiment, the radiation-absorbing compound can be selected for optimization of the color forming composition in a wavelength range from about 600 nm to about 720 nm, such as about 650 nm. Non-limiting examples of suitable radiation-absorbing compound for use in this range of wavelengths can include indocyanine dyes such as 3H-indolium,2-[5-(1,3-dihydro-3,3-dimethyl-1-propyl-2H-indol-2-ylidene)-1,3-pentadienyl]-3,3-dimethyl-1-propyl-,iodide) (Dye 724 Amax 642 nm), 3H-indolium, 1-butyl-2-[5-(1-butyl-1,3-dihydro-3,3-dimethyl-2H-indo!-2-ylidene)-1,3-pentadienyl]-3,3-dimethyl-perchlorate (Dye 683 Aₘₐₓ 642 nm), and phenoxazine derivatives such as phenoxazin-5-ium, 3,7-bis(diethylamino)-perchlorate (oxazine 1 Aₘₐₓ=645 nm). Phthalocyanine dyes having an Aₘₐₓ of about the desired development wavelength can also be used such as silicon 2,3-napthalocyanine bis(trihexylsilyloxide) and matrix soluble derivatives of 2,3-napthalocyanine (both commercially available from Aldrich Chemical); matrix soluble derivatives of silicon phthalocyanine (as described in Rodgers, A. J. et al., 107 J. Phys. Chem. A 3503-3514, May 8, 2003), and matrix soluble derivatives of benzophthalocyanines (as described in Aoudia, Mohamed, 119 J. Am. Chem. Soc. 6029-6039, Jul. 2, 1997); phthalocyanine compounds such as those described in U.S. Pat. Nos. 6,015,896 and 6,025,486, which are each incorporated herein by reference; and Cirrus 715 (a phthalocyanine dye available from Avecia, Manchester, England having an Aₘₐₓ=806 nm).

In another embodiment, laser light having blue and indigo wavelengths from about 300 nm to about 400 nm can be used to develop the color forming compositions. Therefore, the present disclosure can provide color forming compositions optimized within a range for use in devices that emit wavelengths within this range. Recently developed commercial lasers found in certain DVD and laser disk recording equipment provide for energy at a wavelength of about 405 nm. Thus, using appropriate radiation-absorbing compound can be suited for use with components that are already available on the market or are readily modified to accomplish imaging. Radiation-absorbing compounds that can be useful for optimization in the blue (about 405 nm) and indigo wavelengths can include, but are not limited to, aluminum quinoline complexes, porphyrins, porphins, and mixtures or derivatives thereof. Non-limiting specific examples of suitable radiation antenna can include 1-(2-chloro-5-sulfophenyl)-3-methyl-4-(4-sulfophenyl)azo-2-pyrazolin-5-one disodium salt (X max=400 nm); ethyl 7-diethylaminocoumarin-3-carboxylate (X max=418 nm); 3,3′-diethylthiacyanine ethylsulfate (X max=424 nm); 3-allyl-5-(3-ethyl-4-methyl-2-thiazolinylidene)rhodanine (X max=430 nm) (each available from Organica Feinchemie GmbH Wolfen), and mixtures thereof. Non-limiting specific examples of suitable aluminum quinoline complexes can include tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d]1,3-dithiole, all available from Syntec GmbH. Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange CAS 2243-76-7, Merthyl Yellow (60-11-7), 4-phenylazoaniline (CAS 60-09-3), Alcian Yellow (CAS 61968-76-1), available from Aldrich chemical company, and mixtures thereof.

Examples of antenna dyes suitable for imaging with 780 nm laser radiations include, but are not limited to:

a) IR-780 iodide, (Aldrich 42,531-1) (1) (3H-lndolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide(9Cl)),

b) IR783 (Aldrich 54,329-2) (2) (2-[2-[2-Chloro-3-[2-[1,3-dihydro-3,3-dimethyl-1-(4-sulfobutyl)-2H-indol-2-ylidene]-ethylidene]-1-cyclohexen-1-yl]-ethenyl]-3,3-dimethyl-1-(4-sulfobutyl)-3H-indoliumhydroxide, inner salt sodium salt).

c) 3H-lndolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with 4-methylbenzenesulfonic acid (1:1) (9Cl)-(Lambda max −797 nm). CAS No. 193687-61-5. Available from “Few Chemicals GMBH” as S0337.

d) 3H-lndolium, 2-[2-[3-[(1,3-dihydro-1,3,3-trimethyl-2H-indol-2-ylidene)ethylidene]-2-[(1-phenyl-1H-tetrazol-5-yl)thio]-1-cyclohexen-1-yl]ethenyl]-1,3,3-trimethyl-, chloride (9Cl). (Lambda max −798 nm). CAS No. 440102-72-7. Available from “Few Chemicals GMBH” as S0507.

e) 1H-Benz[e]indolium, 2-[2-[2-chloro-3-[(1,3-dihydro-1,1,3-trimethyl-2H-benz[e]indol-2-ylidene)ethylidene]-1-cyclohexen-1-yl]ethenyl]-1,1,3-trimethyl-, chloride (9Cl) (Lambda max −813 nm). CAS No. 297173-98-9. Available from “Few Chemicals GMBH” as S0391.

f) 1H-Benz[e]indolium, 2-[2-[2-chloro-3-[(1,3-dihydro-1,1,3-trimethyl-2H-benz[e]indol-2-ylidene) ethylidene]-1-cyclohexen-1-yl]ethenyl]-1,1,3-trimethyl-, salt with 4-methylbenzenesulfonic acid (1:1) (9Cl) (Lambda max −813 nm). CAS No. 134127-48-3. Available from “Few Chemicals GMBH” as S0094. Also known as Trump Dye or Trump IR.

g) 1H-Benz[e]indolium, 2-[2-[2-chloro-3-[(3-ethyl-1,3-dihydro-1,-dimethyl-2H-benz[e]indol-2-ylidene)ethylidene]-1-cyclohexen-1-yl]ethenyl]-3-ethyl-1,1-dimethyl-, salt with 4-methylbenzenesulfonic acid (1:1) (9Cl) (Lambda max −816 nm). CAS No. 460337-33-1. Available from “Few Chemicals GMBH” as S0809.

In addition, the radiation absorbing compound can include phthalocyanine or naphthalocyanine IR dyes such as Silicon 2,3-naphthalocyanine bis(trihexylsiloxide) (CAS No. 92396-88-8) (Lambda max −775 nm).

The radiation-absorbing compound is from about 0.01 wt % to 10 wt % of the layer and from about 0.1 wt % to 3 wt % of the layer.

Having summarized embodiments, reference will now be made in detail to the illustrative Examples. While the disclosure is described in connection with the Examples, there is no intent to limit the embodiments of the disclosure to the following example. On the contrary, the intent is to cover all alternatives, modifications, and equivalents included within the spirit and scope of the disclosure.

### EXAMPLE 1

The following is an illustrative example of an embodiment of the present disclosure. The image recording coating can be prepared by dissolving the Specialty Red #16 Leuco dye in the UV-curable monomer mix to form a first solution. Then, the other soluble components (e.g., IR780, D8, and Irgacure-1330) are dissolved in the first solution to form a mixture. Subsequently, Foamblast-20F is added to the mixture. To the mixture is added a finely-milled SR709 (mean particle size <=1-2 μm), which is uniformly dispersed in the mixture (using a 3-roll milling process).

| Coating with magenta color development | wt % |
|---|---|
| UV-curable monomer mix | 64% |
| Specialty Red #16 Leuco-dye | 7% |
| IR780 Antenna dye | 1% |
| 4-Hydroxy-4′-isopropoxydiphenyl sulfone (D8) | 1% |
| Irgacure-1300 | 6% |
| Foamblast-20F | 2% |
| SR709 (Zinc Monomethacrylate) as Developer | 20% |
| Total | 100% |

| UV-curable monomer mix | wt. % |
|---|---|
| SR238 | 25% |
| SR506 | 35% |
| Ebecryl-605 | 26% |
| SR306HP | 14% |
| Total | 100% |

### EXAMPLE 2

The following is an illustrative example of an embodiment of the present disclosure. The soluble components (e.g., IR780, D8, and lrgacure-1330) are dissolved in the first solution (same as in the Example #1). Subsequently, Foamblast-20F is added to the mixture. Then a finely-milled S205 leuco-dye is dispersed in the mixture. Also, a finely-milled SR709 (mean particle size <=1-2 μm) is uniformly dispersed in the mixture (using a 3-roll milling process).

| Coating with black color development | wt % |
|---|---|
| UV-curable monomer mix (as described above) | 70% |
| S205 Leuco-dye (1 μm) | 10% |
| IR780-40%/D8 Alloy | 1% |
| Irgacure-1300 | 7% |
| Foamblast-20F | 2% |
| SR709 (Zinc Monomethacrylate) as Developer | 10% |
| Total | 100% |

### EXAMPLE 3

The following is an illustrative example of an embodiment of the present disclosure. The soluble components (e.g., IR780, D8, and Irgacure-1330) are dissolved in the first solution (same as in the Example #1). Subsequently, Foamblast-20F is added to the mixture. Then, a finely-milled Pergascript Black IR leuco-dye is dispersed in the mixture. Also, a finely-milled SR709 (mean particle size <=1-2 μm) is uniformly dispersed in the mixture (using a 3-roll milling).

| Coating with black color development | wt % |
|---|---|
| UV-curable monomer mix (as described above) | 70% |
| Pergascript Black IR Leuco-dye (1 μm) | 10% |
| IR780-40%/D8 Alloy | 1% |
| Irgacure-1300 | 7% |
| Foamblast-20F | 2% |
| SR709 (Zinc Monomethacrylate) as Developer | 10% |
| Total | 100% |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’ ” includes “about ‘x’to about ‘y’”.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. An image recording coating comprising:
a substrate having a layer disposed thereon, wherein the layer includes:
a matrix;
a radiation-absorbing compound;
an activator, wherein the activator is a metal salt of ethylenically unsaturated monocarboxylic acid; and
a color former.

2. The image recording coating of claim 1, wherein the metal salt of ethylenically unsaturated monocarboxylic acid is a zinc salt of ethylenically unsaturated monocarboxylic acid.

3. The image recording coating of claim 2, wherein the zinc salt of ethylenically unsaturated monocarboxylic acid is selected from a zinc mono-acrylate, a zinc mono-methacrylate, a zinc di-acrylate, a zinc di-methacrylate, and combinations thereof.

4. The image recording coating of claim 1, wherein the layer includes: matrix in an amount of about 2 to 98 weight percent of the layer, the radiation-absorbing compound in an amount of about 0.01 to 10 weight percent of the layer, the activator in an amount of about 0.5 to 50 weight percent of the layer, and the color former in an amount of about 2 to 50 weight percent of the layer.

5. The image recording coating of claim 1, wherein the substrate is selected from a paper medium, a transparency, an optical data disc, compact disk (CD), and a digital video disk (DVD).

6. The image recording coating of claim 1, wherein the substrate is an optical disk format selected from one the following: DVD-HD, Blu-ray, DVD, DVD-R, DVD-RW, DVD+R, DVD+RW, DVD-RAM, CD, CD-ROM, CD-R, and CD-RW.

7. The image recording coating of claim 1, wherein the substrate is selected from cardboard and plastic.

8. The image recording coating of claim 1, wherein the radiation-absorbing compound absorbs at about 780 nm wavelength.

9. An optical disk comprising:
image recording coating that includes:
a matrix;
a radiation-absorbing compound;
an activator, wherein the activator is a metal salt of ethylenically unsaturated monocarboxylic acid; and
a color former.

10. The optical disk of claim 9, wherein the metal salt of ethylenically unsaturated monocarboxylic acid is a zinc salt of ethylenically unsaturated monocarboxylic acid.

11. The optical disk of claim 10, wherein the zinc salt of ethylenically unsaturated monocarboxylic acid is selected from a zinc mono-acrylate, a zinc mono-methacrylate, a zinc di-acrylate, a zinc di-methacrylate, and combinations thereof.

12. The optical disk of claim 9, wherein the optical disk is selected from a compact disk (CD) and a digital video disk (DVD), DVD-HD, Blu-ray.

13. The optical disk of claim 9, wherein the optical disk is selected from one the following: DVD-HD, Blu-ray, DVD, DVD-R, DVD-RW, DVD+R, DVD+RW, DVD-RAM, CD, CD-ROM, CD-R, and CD-RW.

14. The optical disk of claim 9, wherein the optical disk stores digital data.

15. A method for preparing a recording medium, the method comprising:
providing a matrix, a radiation-absorbing compound, an activator, and a color former, wherein the activator is a metal salt of ethylenically unsaturated monocarboxylic acid;
mixing the radiation-absorbing compound, the activator, and the color former, in the matrix to form a matrix mixture; and
disposing the matrix mixture onto a substrate.

16. The method of claim 15, wherein the substrate is selected from a paper medium, a transparency, a compact disk (CD), and a digital video disk (DVD), DVD-HD, Blu-ray.

17. The method of claim 15, wherein the substrate is an optical disk that stores digital data.

18. The method of claim 15, wherein the substrate is an optical disk format selected from one the following: DVD-HD, Blu-ray, DVD, DVD-R, DVD-RW, DVD+R, DVD+RW, DVD-RAM, CD, CD-ROM, CD-R, and CD-RW.

19. The method of claim 15, wherein the wherein the metal salt of ethylenically unsaturated monocarboxylic acid is a zinc salt of ethylenically unsaturated monocarboxylic acid.

20. The method of claim 15, wherein the wherein the zinc salt of ethylenically unsaturated monocarboxylic acid is selected from a zinc mono-acrylate, a zinc mono-methacrylate, a zinc di-acrylate, a zinc di-methacrylate, and combinations thereof.
